(19) United States
(12) Patent Application Publication
(10) Pub. No.: US 2024/0354158 A1
(43) Pub. Date: Oct. 24, 2024

(54) TASK PLATFORM DISPLAY METHOD AND APPARATUS, DEVICE, AND COMPUTER PROGRAM PRODUCT

(71) Applicant: Tencent Technology (Shenzhen ) Company Limited, Shenzhen (CN)

(72) Inventors: Beilin LIU, Shenzhen (CN); Hongwei Wen, Shenzhen (CN); Bangjian Yin, Shenzhen (CN)

(73) Assignee: Tencent Technology (Shenzhen ) Company Limited, Shenzhen (CN)

(21) Appl. No.: 18/763,609

(22) Filed: Jul. 3, 2024

Related U.S. Application Data
(63) Continuation of application No. PCT/CN2023/116787, filed on Sep. 4, 2023.

(30) Foreign Application Priority Data
Sep. 16, 2022 (CN) 202211132203.7

(51) Int. Cl. G06F 9/48

(52) U.S. Cl. CPC G06F 9/4881

(57) ABSTRACT

A task platform display method, performed by a terminal, includes: receiving a start operation for starting a task platform corresponding to a first account; displaying, based on the start operation and the first account corresponding to a first task permission, a first task platform including a first number of first task options; receiving a platform switching operation for switching the task platform from the first task platform to a second task platform including a second number of second task options, the first number being less than the second number; and displaying, based on the platform switching operation and the first account corresponding to a second task permission, the second task platform.

### CROSS-REFERENCE TO RELATED APPLICATIONS

This application is a continuation application of International Application No. PCT/CN2023/116787 filed on Sep. 4, 2023, which claims priority to Chinese Patent Application No. 202211132203.7 filed with the China National Intellectual Property Administration on Sep. 16, 2022, the disclosures of each being incorporated by reference herein in their entireties.

### FIELD

The disclosure relates to the field of computer technologies, and in particular, to a task platform display method and apparatus, a device, and a computer program product.

### BACKGROUND

In a game (for example, multiplayer online role-playing games), game developers may launch various game activities, and users may participate in the game activities to obtain activity rewards.

In the related art, an activity center is may be provided for the users. The activity center may be a platform that integrates different activities in the game, which may provide types of information guidance, activity entrances, and the like. The users may participate in various game activities through the activity center, thereby completing tasks provided by the game activities.

However, information and functions included in the activity center provided in the related art are complex, which may distract attention of a user from a task, and may reduce the efficiency of human-computer interaction between the user and the task.

### SUMMARY

Provided are a method and an apparatus for displaying a task platform, a device, and a computer program product.

According to some embodiments, a task platform display method, performed by a terminal, includes: receiving a start operation for starting a task platform corresponding to a first account; displaying, based on the start operation and the first account corresponding to a first task permission, a first task platform including a first number of first task options; receiving a platform switching operation for switching the task platform from the first task platform to a second task platform including a second number of second task options, the first number being less than the second number; and displaying, based on the platform switching operation and the first account corresponding to a second task permission, the second task platform.

According to some embodiments, a task platform display apparatus, includes: at least one memory configured to store computer program code; and at least one processor configured to read the program code and operate as instructed by the program code, the program code including: platform start operation code configured to cause at least one of the at least one processor to receive a start operation for starting a task platform corresponding to a first account; first task platform display code configured to cause at least one of the at least one processor to display, based on the start operation and the first account corresponding to a first task permission, a first task platform including a first number of first task options; platform switching code configured to cause at least one of the at least one processor to receive a platform switching operation for switching the task platform from the first task platform to a second task platform including a second number of second task options, the first number being less than the second number; and second task platform display code configured to cause at least one of the at least one processor to display, based on the platform switching operation and the first account corresponding to a second task permission, the second task platform.

According to some embodiments, a non-transitory computer-readable storage medium, storing computer code which, when executed by at least one processor, causes the at least one processor to at least: receive a start operation for starting a task platform corresponding to a first account; display, based on the start operation and the first account corresponding to a first task permission, a first task platform including a first number of first task options; receive a platform switching operation for switching the task platform from the first task platform to a second task platform including a second number of second task options, the first number being less than the second number; and display, based on the platform switching operation and the first account corresponding to a second task permission, the second task platform.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an implementation environment according to some embodiments.

FIG. 2 is a flowchart of a task platform display method according to some embodiments.

FIG. 3 is a schematic diagram of a first task platform according to some embodiments.

FIG. 4 is a schematic diagram of a platform switching operation according to some embodiments.

FIG. 5 is a schematic diagram of a second task platform according to some embodiments.

FIG. 6 is a flowchart of a task platform switching method according to some embodiments.

FIG. 7 is a schematic diagram of task platform switching according to some embodiments.

FIG. 8 is a schematic diagram of actively unlocked rewards according to some embodiments.

FIG. 9 is a schematic diagram of a second task prompt according to some embodiments.

FIG. 10 is a schematic diagram of unlocking guidance according to some embodiments.

FIG. 11 is a flowchart of an automatic unlocking method of a second task platform according to some embodiments.

FIG. 12 is a schematic diagram of automatic unlocking of a second task platform according to some embodiments.

FIG. 13 is a timing diagram of communication between a client and a server according to some embodiments.

FIG. 14 is a schematic diagram of an event-driven task platform state according to some embodiments.

FIG. 15 is a schematic diagram of the logic of a client according to some embodiments.

FIG. 16 is a structural diagram of a task platform display apparatus according to some embodiments.

FIG. 17 is a structural diagram of a task platform display apparatus according to some embodiments.

FIG. 18 is a structural block diagram of a terminal according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In a virtual scene, various activities are provided for users, and the users may participate in the activities to obtain activity rewards. In the related art, an activity center is usually provided for the users. The activity center is a platform that integrates different activities in the virtual scene, which provides a plurality of types of information guidance, a plurality of activity entrances, and the like. The users may participate in various activities through the activity center, thereby completing tasks provided by the activities.

In some embodiments, the virtual scene may be a game virtual scene or a social application scene. For example, in the game virtual scene, users learn activity information and the like through a game activity center. In the social application scene, users obtain task guidance, makes an account level up to expand a capacity of a social list, and the like through a task platform. The virtual scene is an example and is not limited.

Some embodiments provide a task platform display method. A first task platform with less tasks is displayed before a second task platform with more tasks is displayed. The first task platform refers to an activity center provided for users and displaying less tasks. Based on a user triggering a platform switching operation and a task permission of the user is adjusted from a first task permission to a second task permission, the first task platform is switched to the second task platform, and the second task platform displays more tasks. By displaying the task platform in stages, the user is given a transitional experience to the task platform, thereby improving the attention of the user in the task at each stage, and preventing the user from searching in complex information, so that the user can quickly locate a task to be performed, and efficiency of human-computer interaction between the user and the task is improved.

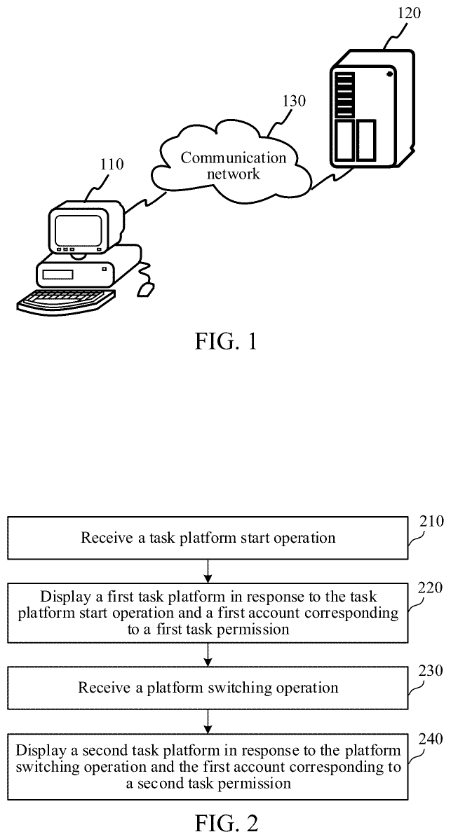

First, an implementation environment is introduced. FIG. 1 is a schematic diagram of an implementation environment according to some embodiments. The implementation environment includes: a terminal 110, a server 120, and a communication network 130. The communication network 130 may be a wired network or a wireless network.

The terminal 110 is installed with a target application corresponding to a task platform. The target application is an application supporting a virtual environment, for example, an application supporting a three-dimensional virtual environment. The target application may be any one of a virtual reality application, a three-dimensional map application, a third-person shooting (TPS) game, a first-person shooting (FPS) game, or a multiplayer online battle arena (MOBA) game. In some embodiments, the application may be a standalone application, such as a standalone three-dimensional game application, or may be an online application.

In some embodiments, the terminal 110 and the server 120 communicate with each other through the communication network 130. Based on a first account corresponding to the terminal 110 logging in to a target application, a state request of a task platform in the current target application is sent to the server 120. Based on receiving the state request, the server 120 sends a state reply of the current task platform to the terminal 110. The reply includes a state of the current task platform and a task that may be displayed in the current task platform. In some embodiments, the task platform state includes a locked state, an actively unlockable state, an automatically unlocked receivable reward state, an unlocked and received reward state, and the like.

In some embodiments, based on the current first account of the terminal 110 executing a behavior event that changes a task platform state, the server 120 updates the task platform state and sends a change notification of the task platform state to the terminal 110.

In some embodiments, based on the current task platform of the terminal 110 being in the actively unlockable state, the terminal 110 receives an unlocking operation, and sends a task platform unlocking request to the server 120, and the server 120 sends a task platform unlocking answer to the terminal 110.

The terminal 110 may be terminal devices in a plurality of forms such as a desktop computer, a portable laptop computer, a mobile phone, a tablet computer, an e-book reader, a Moving Picture Experts Group Audio Layer III (MP3) player, a Moving Picture Experts Group Audio Layer IV (MP4) player, a smart television, and a smart vehicle. This is not limited.

The server 120 may be an independent physical server, or may be a server cluster or a distributed system formed by a plurality of physical servers, or may be a cloud server that provides cloud computing services such as a cloud service, cloud security, a cloud database, cloud computing, a cloud function, cloud storage, a network service, cloud communication, a middleware service, a domain name service, a security service, a content delivery network (CDN), big data, and an artificial intelligence platform.

The cloud technology is a hosting technology that unifies a series of resources such as hardware, software, and networks in a wide area network or a local area network to implement computing, storage, processing, and sharing of data. In some embodiments, the server 120 may be implemented as a node in a blockchain system.

The information (including, but not limited to, user equipment information, user personal information, and the like), data (including, but not limited to, data for analysis, stored data, displayed data, and the like), and signals all are authorized by the user or fully authorized by each party, and the collection, use, and processing of relevant data may need to comply with relevant laws, regulations, and standards.

For example, FIG. 2 is a flowchart of a task platform display method according to some embodiments. The method may be applicable to a terminal, a server, or both a terminal and a server. Some embodiments is described by using an example in which the method is applicable to a terminal. As shown in FIG. 2, the method includes the following operations.

Operation 210: Receive a task platform start operation.

The task platform start operation is configured for starting a task platform corresponding to a first account.

For example, the task platform is a task platform provided in a target application. The task platform is configured for carrying various tasks published in the target application. The target application is logged in with the first account.

In some embodiments, the task platform start operation includes a trigger operation for a task platform start control.

For example, the task platform start control is displayed in a virtual scene interface provided by the target application; and the trigger operation for the task platform start control is received to start the task platform.

The trigger operation may be implemented as operation manners such as click, press and hold, slide, voice instruction control, and gesture instruction control. This is not limited.

In some embodiments, displaying the task platform start control may be implemented as hiding the task platform start control by default. In response to a task permission corresponding to the first account being adjusted, the task platform start control is triggered to be displayed, or the task platform start control is always displayed by default.

For example, in response to the first account completing a task A, the first account corresponds to a first task permission; in response to the first account corresponding to the first task permission, the task platform start control is displayed; and the trigger operation for the task platform start control is received to start the task platform. In response to an account level of the first account reaching a preset level, the first account may correspond to the first task permission; in response to the first account corresponding to the first task permission, the task platform start control may be displayed; and the trigger operation for the task platform start control may be received to start the task platform.

The task platform start control may always be displayed by default; and the trigger operation for the task platform start control displayed by default may be received to start the task platform.

In some embodiments, the task platform start operation includes an operation automatically triggered based on the task permission corresponding to the first account being adjusted.

For example, in response to the first account completing a first preset task B, the first account corresponds to the first task permission; and in response to the first account corresponding to the first task permission, the task platform is started. In response to an account level of the first account reaching a preset level, the first account may correspond to the first task permission; and in response to the first account corresponding to the first task permission, the task platform may be started. In response to an account level of the first account reaching a preset level and the first account completing a first preset task B, the first account may correspond to the first task permission; and in response to the first account corresponding to the first task permission, the task platform may be started.

Operation 220: Display a first task platform in response to the task platform start operation and a first account corresponding to a first task permission.

The first task platform includes a first number of first task options.

For example, the first task option is configured for triggering a task corresponding to the first task permission. The task corresponding to the first task permission refers to a task (or an activity) in which the first account may currently participate. Based on the first account having the first task permission, the first account can participate in less tasks.

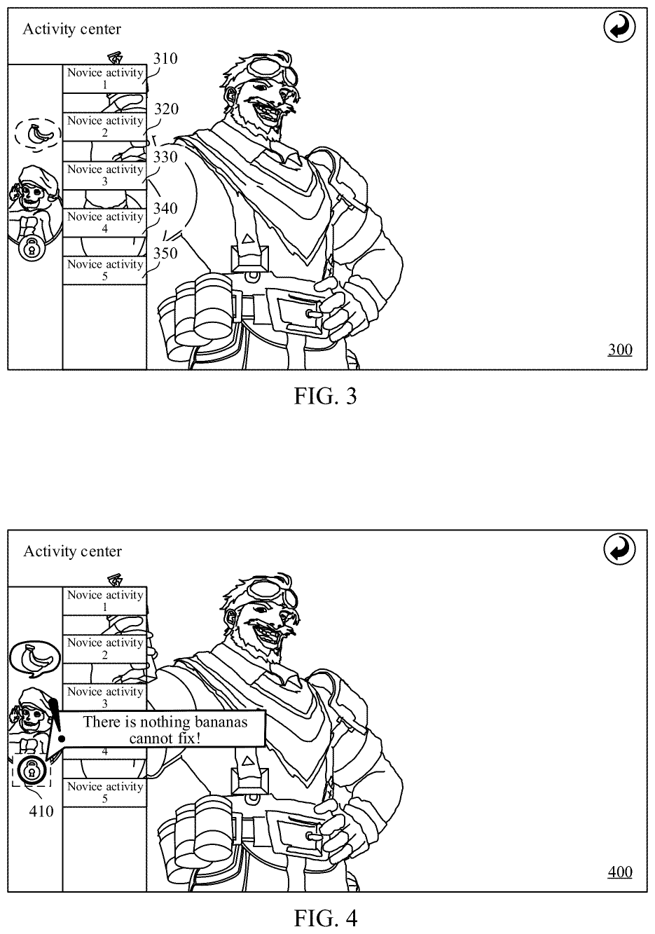

FIG. 3 is a schematic diagram of a first task platform according to some embodiments. As shown in FIG. 3, the first task platform 300 is displayed in response to the task platform start operation and the first account completing the first preset task B, for example, the first account corresponding to the first task permission. The first task platform 300 includes a total of five first task options: a first task option 310 to a first task option 350.

Operation 230: Receive a platform switching operation.

The platform switching operation is configured for indicating to switch from the first task platform to a second task platform.

In some embodiments, the platform switching operation may be implemented as at least one of an operation of triggering a platform switching control, a page slide operation for the first task platform, a page zoom operation for the first task platform, or the like. This is not limited in some embodiments.

For example, based on the first task platform changing from a locked display page state to a slidable state, the user slides a page of the first task platform leftward by a specified distance to a display page of a current terminal to display a complete second task platform.

For example, a two-finger zoom-out operation is performed on the first task platform to a preset size, to switch to display the second task platform; or a two-finger zoom-in operation is performed on the first task platform to a preset size, to switch to display the second task platform.

For example, a platform switching control is displayed in the first task platform, and a trigger operation for the platform switching control is received as the platform switching operation.

FIG. 4 is a schematic diagram of a platform switching operation according to some embodiments. As shown in FIG. 4, a trigger operation for a platform switching control 410 is received. In some embodiments, the trigger operation may be implemented as an operation such as click, press and hold, or drag on the platform switching control 410.

In some embodiments, the target application is implemented as an application provided with a virtual scene. In some embodiments, the task platform is an element displayed in a virtual scene provided by the terminal, the first account corresponds to a first virtual character, and the first task platform corresponds to a first virtual space.

The first virtual space may be implemented as a virtual location of the virtual scene, for example, a virtual house publishing a task or a virtual billboard publishing a task in the virtual scene.

The displaying a first task platform in response to the task platform start operation and a first account corresponding to a first task permission includes: displaying, in response to the task platform start operation and the first account corresponding to the first task permission, the first virtual character entering the first virtual space, the first virtual space including first subspaces respectively corresponding to the first number of first task options.

For example, based on the task platform start operation being triggered, the first virtual character enters the first virtual space. The first virtual space includes a plurality of first subspaces. Each first subspace represents one first task option. For example, the virtual house includes a plurality of task bars. Each task bar represents one first task option. Controlling the first virtual character to move to the task bar represents that the first virtual character can view task information corresponding to the task bar, or represents that the first virtual character starts to perform a task corresponding to the task bar.

The receiving a platform switching operation includes: receiving a control operation for the first virtual character in the virtual scene; and triggering the platform switching operation in response to a distance between the first virtual character and a first virtual element in the first virtual space being less than or equal to a preset distance, the platform switching operation being configured for switching a virtual space in which the first account is located from the first virtual space to a second virtual space corresponding to the second task platform, the second virtual space including a second number of second subspaces respectively corresponding to a second number of second task options.

Each second subspace represents one second task option. The first virtual element may be an object (for example, a treasure box or a transfer entrance) in the first virtual space, or the first virtual element may be a non-player character in the first virtual space. This is not limited.

For example, based on the user controlling the first virtual character to move to the transfer entrance in the first virtual space, a transfer animation is displayed, for example, a transfer animation in which the first virtual character is transferred from the first virtual space (a task space) to the second virtual space (for example, a complete task space).

In some embodiments, the first virtual scene includes a second virtual character. The second virtual character may be a non-player character displayed bound to a virtual location representing the first task platform.

In some embodiments, the control operation for the first virtual character is received; and the platform switching operation is triggered in response to a distance between the first virtual character and the second virtual character being less than or equal to a preset distance.

For example, based on the user controlling the first virtual character to move near the non-player character in the first virtual space, an interactive animation between the first virtual character and the non-player character is displayed, and based on playing of the interactive animation ends, the second virtual space is displayed.

The platform switching operation is an example and is not limited.

Operation 240: Display a second task platform in response to the platform switching operation and the first account corresponding to a second task permission.

The second task platform includes the second number of second task options, and the first number is less than the second number.

For example, the second task option is configured for triggering a task corresponding to the second task permission. The task corresponding to the second task permission refers to a task (or an activity) in which the first account may currently participate. Based on the first account having the second task permission, the first account can participate in more tasks.

In some embodiments, the second task platform further includes information such as a task label, a task reward, a task prompt, a task time limit, a task slogan, and a task indicator.

The task label is configured for indicating a type of the task, for example, a daily task or a limited task. The task reward refers to a reward that may be obtained based on the task being completed. The task prompt refers to information such as a name and content of the task. The task time limit refers to a limit on duration for completing the task. The task slogan refers to slogan information corresponding to the task, or the like. The task indicator refers to an indicator for completing the task, or the like.

In some embodiments, the task label may be a first-level task option provided by the task platform, and the second task option refers to a second-level task option under the task label.

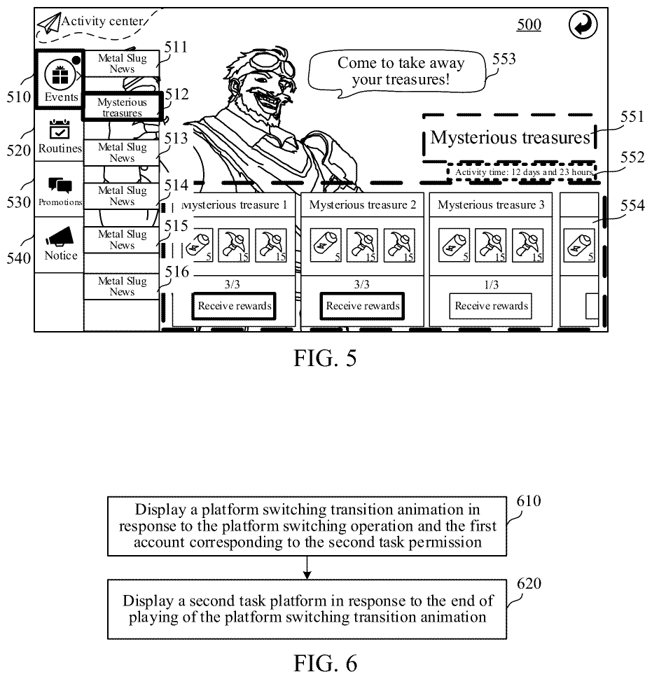

FIG. 5 is a schematic diagram of a second task platform according to some embodiments. As shown in FIG. 5, the second task platform 500 is displayed in response to receiving the platform switching operation and the first account corresponding to the second task permission. The second task platform 500 includes a task label that is not displayed in the first task platform, the second number of second task options, a task reward corresponding to a selected second task option, a module 551 corresponding to the selected second task option, a time limit 552 corresponding to the selected second task option, a task slogan 553 corresponding to the selected second task option, a task prompt corresponding to the selected second task option, a task indicator corresponding to the selected second task option, and the like. For example, a task label 510 includes a corresponding second task option 511 to a second task option 516, and the selected second task option 512 corresponds to a mysterious treasure task reward 554. Similarly, a task label 520 to a task label 540 include several second task options corresponding to them. The second task option may include the first task option in the first task platform.

In summary, according to the method provided by some embodiments, a first task platform with less tasks is displayed before a second task platform with more tasks is displayed. The first task platform refers to an activity center provided for users and displaying less tasks. Based on a user triggering a platform switching operation and a task permission of the user is adjusted from a first task permission to a second task permission, the first task platform is switched to the second task platform, and the second task platform displays more tasks. By displaying the task platform in stages, the user is given a transitional experience to the task platform, thereby improving the attention of the user in the task at each stage, so that efficiency of human-computer interaction between the user and the task is improved.

According to the method provided by some embodiments, based on the task platform start operation being triggered, the first virtual character corresponding to the user entering the first virtual space is displayed, to display the first task platform, thereby improving the display diversity of the first task platform and providing the user with a more realistic task platform implementation effect.

According to the method provided by some embodiments, based on the user controlling the first virtual character to move around the first virtual element in the first virtual space, the first virtual character entering the second virtual space represented by the second task platform is displayed, which enriches the way in which the first task platform is switched to the second task platform, and improves switching efficiency during switching.

In some embodiments, the foregoing operation 240 may be implemented as a task platform switching operation. For example, FIG. 6 is a flowchart of a task platform switching method according to some embodiments. As shown in FIG. 6, the foregoing operation 240 may be implemented as the following operation 610 and operation 620.

Operation 610: Display a platform switching transition animation in response to the platform switching operation and the first account corresponding to the second task permission.

The platform switching transition animation is a transition animation for switching the task platform corresponding to the first account from the first task platform to the second task platform.

In some embodiments, the platform switching operation is a switching operation performed by the first account for the first time from a preset historical moment. In some embodiments, the preset historical moment may be a period of time from creation of an account to date, or a period of resetting account information based on a fixed period of time ending, for example, every season, every month, or every period of time during which the account is logged on and off.

For example, the platform switching transition animation is displayed in response to the first account corresponding to the second task permission and the first account performing the platform switching operation for the first time since the first account corresponds to the second task permission.

In some embodiments, operation 610 may be implemented as the following two operations.

First operation: Display an unlocking animation in response to the platform switching operation and the first account corresponding to the second task permission.

The unlocking animation is configured for indicating to unlock the second task platform based on the first task platform.

For example, the unlocking animation may be a preset plot animation that welcomes users to enter a formal activity center in a current game virtual scene world view, for example, enter a formal plot line in the game world view, or the unlocking animation may be a preset celebration animation, for example, playing a firework special effect.

The unlocking animation is an example and is not limited.

Second operation: Display the platform switching transition animation in response to the end of playing of the unlocking animation.

For example, a preset unlocking animation corresponding to unlocking the second task platform based on the first task platform is displayed in response to triggering the platform switching control and the first account completing a preset second task, for example, the first account corresponding to the second task permission; and the transition animation for switching from the first task platform to the second task platform is displayed in response to the end of playing of the unlocking animation.

For example, the transition animation may be that a special effect of an unlocking control is played, and a special effect of a task label for the second task platform is played at the position. The transition animation may be that the screen dims to all black and lights up to display the second task platform until the end of playing of the special effect. The transition animation may be that the screen is blocked by smoke, and a smoke dissipation animation is played on the second task platform until the smoke disappears. An animation in which the first task platform flies out of the screen may be played, and an animation in which the second task platform flies into the screen may be played until the second task platform is completely displayed in the screen.

The transition animation is an example and is not limited.

In some embodiments, the unlocking animation is displayed in response to the platform switching operation, the first account corresponding to the second task permission, and the first account performing the platform switching operation for the first time since the first account corresponds to the second task permission; and the platform switching transition animation is displayed in response to the end of playing of the unlocking animation.

Operation 620: Display a second task platform in response to the end of playing of the platform switching transition animation.

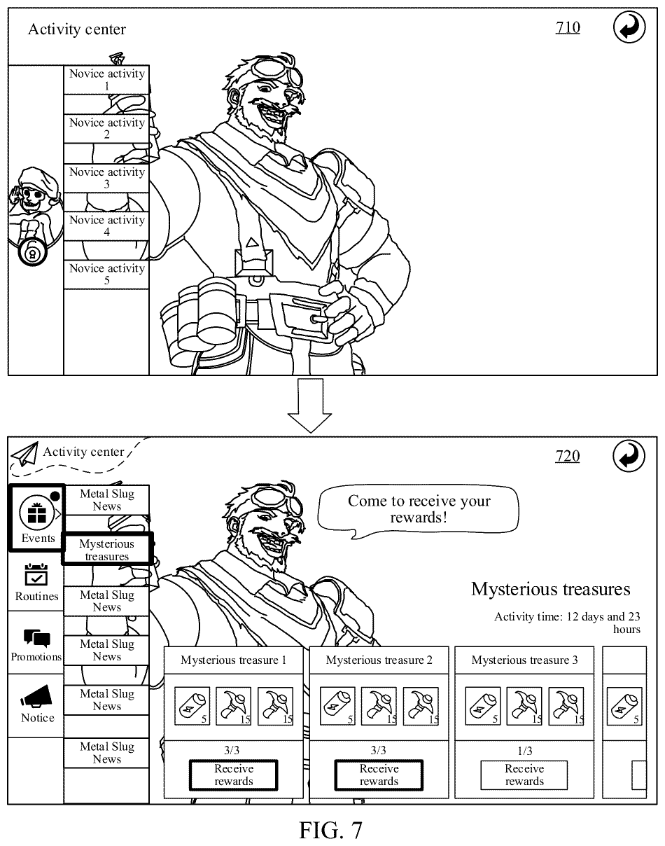

For example, FIG. 7 is a schematic diagram of task platform switching according to some embodiments. A second task platform 720 is displayed in response to the end of playing of the platform switching transition animation, so that a switching process from a first task platform 710 to the second task platform 720 shown in FIG. 7 is completed.

In some embodiments, the task platform switching method may further include the following display solutions.

1. Display first reward prompt information in response to the platform switching operation and the first account corresponding to the second task permission.

The first reward prompt information is configured for prompting a reward obtained by the first account after unlocking the second task platform based on the first task platform.

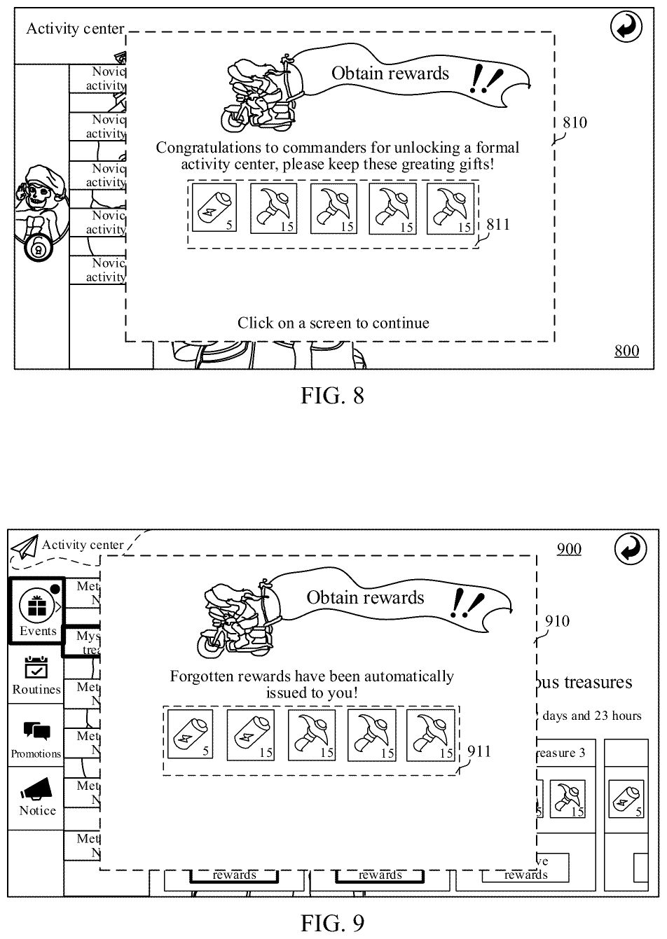

For example, FIG. 8 is a schematic diagram of a first reward prompt according to some embodiments. As shown in FIG. 8, in response to the platform switching operation and the first account corresponding to the second task permission, first reward prompt information 810 is displayed on a first task platform 800, including an actively unlocked reward 811 obtained by the first account after unlocking the second task platform based on the first task platform. For example, in response to the platform switching operation and the first account corresponding to the second task permission, the first reward prompt information is displayed before a platform transition animation is displayed.

In some embodiments, the task platform switching method may further include the following display solutions.

2. Display second reward prompt information in response to the platform switching operation and the first account corresponding to the second task permission.

The second reward prompt information is configured for prompting a reward not received by the first account in the first task platform, the second reward prompt information corresponds to a completed task in the first task platform, and the completed task is configured in the first task platform and is not configured in the second task platform.

For example, FIG. 9 is a schematic diagram of a second reward prompt according to some embodiments. As shown in FIG. 9, in response to the platform switching operation and the first account corresponding to the second task permission, second reward prompt information 910 is displayed on a second task platform 900, including a reward 911 not received by the first account that has completed the task in the first task platform. For example, in response to the platform switching operation and the first account corresponding to the second task permission, the second reward prompt information is displayed based on the second task platform being displayed.

In summary, according to the method provided by some embodiments, the platform switching transition animation is displayed based on the platform switching operation being triggered, so that smooth transition from the first task platform to the second task platform is implemented, platform switching forms are enriched, perception for a task platform switching action by the user is improved, and efficiency of human-computer interaction is improved.

According to the method provided by some embodiments, an unlocking animation on the first task platform is also displayed before the platform switching transition animation is displayed, which gives a rich experience while making the user aware of a stage difference between the first task platform and the second task platform, further improving the perception for the task platform switching action by the user.

According to the method provided by some embodiments, based on the platform switching operation being triggered as the switching operation performed for the first time from the preset historical moment, the platform switching transition animation or the unlocking animation can be displayed, thereby avoiding a waste of display resources caused to the computer device by frequently displaying an animation effect through multiple triggering of the platform switching operation.

According to the method provided by some embodiments, an actively unlocked reward prompt method is provided. For example, based on the user unlocking the second task platform on the first task platform, the first reward prompt information is displayed, to prompt a reward obtained through active unlocking by the user. This improves the user experience in active unlocking, so that the user can quickly learn reward information, and improves efficiency of human-computer interaction.

According to the method provided by some embodiments, an unreceived reward reissue prompt method is provided. For example, based on the user unlocking the second task platform on the first task platform, the second reward prompt information is displayed, to prompt a reward of a task that the user has completed but not received the reward on the first task platform. This avoids reward missing caused by task platform switching, improves the user experience, prevents the user from receiving the missing reward through another entrance, and improves efficiency of human-computer interaction.

In some embodiments, the task platform display method further includes task permission adjustment, which is adjusting a task permission corresponding to the first account from the first task permission to the second task permission. In some embodiments, a task permission adjustment method includes at least one of the following two cases.

First: Adjust the task permission corresponding to the first account from the first task permission to the second task permission in response to a task verification operation and the first account corresponding to the first task permission.

The task verification operation is configured for triggering to adjust the task permission corresponding to the first account from the first task permission to the second task permission.

For example, the first account corresponds to the first task permission based on the first account completing a preset first task; the task verification operation is triggered in response to the first account completing a preset second task; and the first account is adjusted from the first task permission to the second task permission, for example, the first account is adjusted to a state that a second task is completed, in response to the task verification operation. In some embodiments, the task verification operation may be implemented as displaying task reward prompt information, the first task permission may be implemented as a state that a first task is completed, and the second task permission may be implemented as the state that the second task is completed.

In some embodiments, unlocking guidance is displayed based on the first task permission adjustment method. For example, in response to the task verification operation and the first account corresponding to the first task permission, based on the first account being adjusted from the first task permission to the second task permission, a guidance element is displayed on the first task platform in response to the first account corresponding to the second task permission, the guidance element being configured for prompting to trigger the platform switching operation.

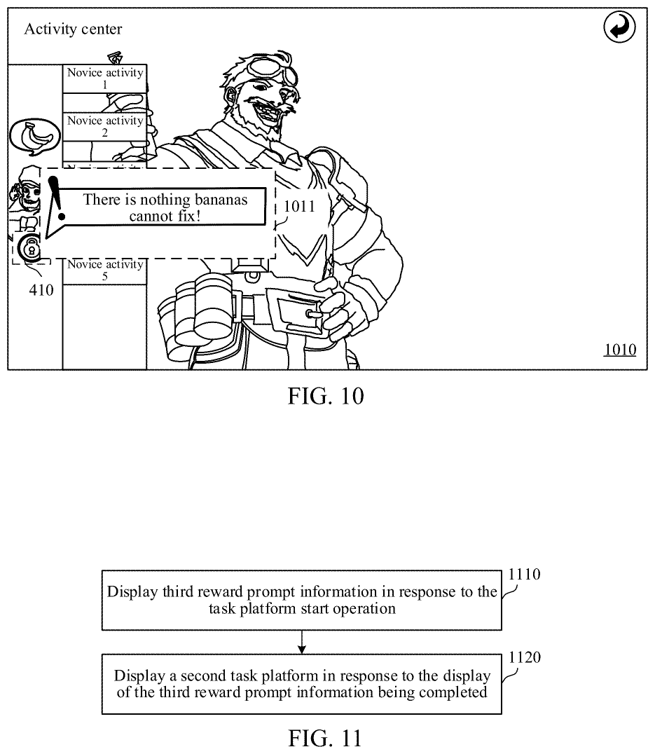

For example, FIG. 10 is a schematic diagram of unlocking guidance according to some embodiments. As shown in FIG. 10, a guidance element 1011 is displayed on a first task platform 1010 in response to the first account corresponding to the second task permission.

In some embodiments, the first task permission adjustment method may include triggering the task verification operation in a case that a preset task is completed.

The preset task includes at least one of the following tasks:
a task configured based on preference information corresponding to the first account;
a task configured based on account information corresponding to the first account; and
a task configured based on capability information corresponding to the first account.

For example, an indicator corresponding to a preset task is adjusted based on preference information of an account. For example, the preset task includes collecting a specified number of virtual objects in the virtual scene, defeating a virtual character of a specified level, travelling by a specified distance, and consuming a specified number of virtual items. Based on the preference information corresponding to the first account being collection, a specified number of virtual objects collected in the virtual scene in the preset task is set to a number greater than a default number, and the task verification operation is triggered in response to the first account completing the preset task. Based on the preference information of the first account being collection, the preset task may be configured as a collection task in which the first account collects a specified number of virtual objects in the virtual scene, and the task verification operation may be triggered in response to the first account completing the collection task. According to preference information of the first account being battle, the preset task may be configured as that the first account participates in a specified battle in the virtual scene, and the task verification operation may be triggered in response to the first account completing the battle task.

For example, based on the account information of the first account, such as age, based on age information being between 22 and 30 years old, the preset task is configured as a plot task of obtaining a specified compensation by completing a work plot, and the like, and the task verification operation is triggered in response to the first account completing the job plot task. Based on the age information being between 18 and 22 years old, the preset task is configured as a plot task of obtaining a specified credit by completing a learning story, and the like, and the task verification operation is triggered in response to the first account completing the learning plot task.

For example, based on the account information corresponding to the first account, such as a corresponding virtual character, four virtual characters are preset in a game scene, and different virtual characters correspond to different plot tasks in the current game world view. The preset task is configured as a plot task corresponding to the virtual character in the current game world view, and the task verification operation is triggered in response to the first account completing the plot task.

For example, based on the capability information corresponding to the first account, such as an experience value, based on the experience value exceeding a specified threshold, a preset task completion indicator is set to a higher threshold. For example, if the preset task is to consume a specified number of virtual items by default, the specified number of the virtual items of the preset task is set to twice the default number. Based on the experience value being less than half of the specified threshold, the preset task completion indicator is set to a lower threshold. For example, if the preset task is to consume a specified number of virtual items by default, the specified number of the virtual items of the preset task is set to half of the default number.

The preset task is an example and is not limited.

Second: Adjust the task permission corresponding to the first account from the first task permission to the second task permission in response to the first account reaching a preset level threshold and the first account corresponding to the first task permission.

Based on the first account corresponding to the first task permission, a level of the first account is less than the level threshold, and based on the first account corresponding to the second task permission, the level of the first account is greater than or equal to the level threshold.

For example, based on the first account completing the preset first task and the first account corresponds to the first task permission, in response to the first account reaching the preset level from a current level, for example, corresponding to the preset level threshold, the first account is adjusted from the first task permission to the second task permission. In some embodiments, the first task permission may be implemented as a state that the first task is completed, and the second task permission may be implemented as a state that the second task is not completed and the level threshold is reached.

In some embodiments, the task platform is displayed based on the second task permission adjustment method, for example, the second task platform is automatically unlocked based on the second task permission adjustment method. For example, in response to the first account corresponding to the level threshold and the first account corresponding to the first task permission, based on the first account being adjusted from the first task permission to the second task permission, the second task platform is displayed in response to the task platform start operation. For example, FIG. 11 is a flowchart of an automatic unlocking method of a second task platform according to some embodiments. As shown in FIG. 11, the method includes the following operations.

Operation 1110: Display third reward prompt information in response to the task platform start operation.

The third reward prompt information is configured for prompting a reward obtained by the first account after unlocking the second task platform based on the level threshold, for example, a reward automatically unlocked by the second task platform.

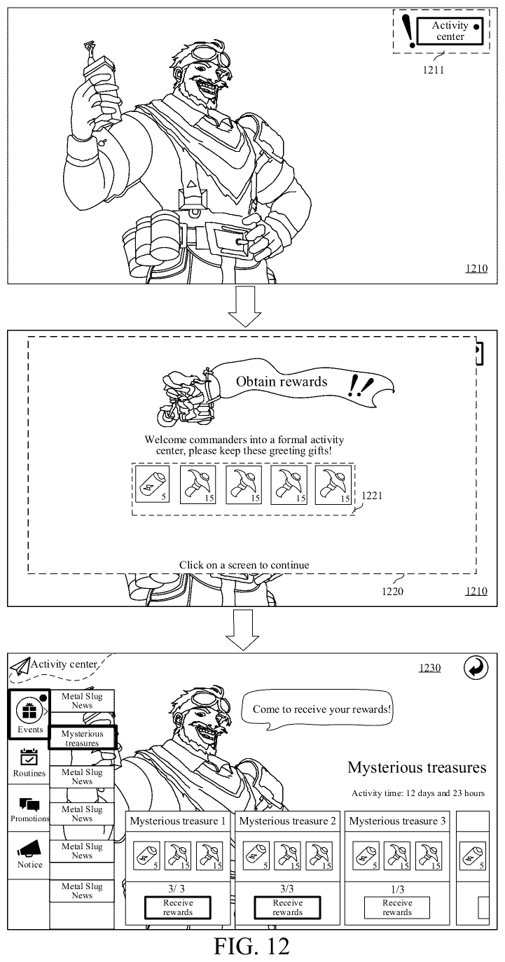

For example, FIG. 12 is a schematic diagram of automatic unlocking of a second task platform according to some embodiments. As shown in FIG. 12, in response to a task platform start control 1211 in a corresponding virtual scene interface 1210 being triggered, third reward prompt information 1220 is displayed in the corresponding virtual scene interface 1210. The third reward prompt information 1220 includes automatically unlocked rewards 1221 of the second task platform.

Operation 1120: Display the second task platform in response to the display of the third reward prompt information being completed.

For example, as shown in FIG. 12, a second task platform 1230 is displayed in response to the display of third reward prompt information 1220 being completed.

In some embodiments, a third task reward display completion condition may be implemented as that preset display duration is reached, or a display close operation is performed.

In summary, according to the method provided by some embodiments, a permission adjustment method is provided. For example, based on the first task permission being adjusted to the second task permission, switching from the first task platform to the second task platform can be implemented, a display condition of the second task platform is limited, the number of users using the second task platform is limited to some extent, and maintenance costs of the task platform are reduced.

According to the method provided by some embodiments, a plurality of permission adjustment manners is provided, and the user can actively perform permission adjustment through a task or automatically perform permission adjustment based on leveling up, which enriches the permission adjustment manners and improves user experience.

According to the method provided by some embodiments, based on the user actively performing permission adjustment through a task, the preset task can be implemented as a task configured based on various types of information of the first account, so that the operation of the user performing permission adjustment can be consistent with the personality of the user, and the initiative of the user performing adjustment is promoted, thereby improving efficiency of the user performing permission adjustment.

According to the method provided by some embodiments, based on the user automatically performing permission adjustment by leveling up, and based on the level of the user being up to the level threshold, the task permission of the user is automatically adjusted to the second task permission. In addition, based on the user entering the task platform, the second task platform is displayed, and display of an interface of the first task platform is skipped, thereby reducing the operations for entering the second task platform, and improving efficiency of human-computer interaction.

According to the method provided by some embodiments, an automatically unlocked reward display method is provided. For example, based on the level of the user being up to the level threshold, and based on the user entering the task platform, the third reward prompt information is displayed, to prompt the reward obtained by the first account after unlocking the second task platform based on the level threshold, thereby improving display efficiency of the task reward.

According to the method provided by some embodiments, a guidance element display method is provided, which improves unlocking guidance of the second task platform and improves efficiency of unlocking interaction.

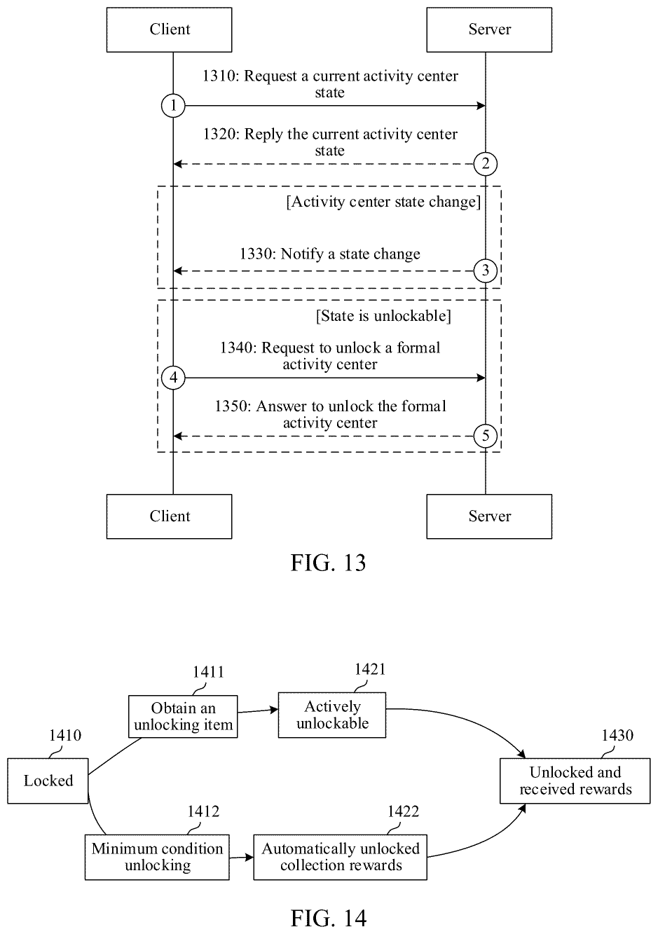

In some embodiments, the task platform display method further includes communication between the client and the server. The server drives a state change of the task platform through an event mechanism. A task that may be displayed in the task platform depends on the state of the task platform. In some embodiments, the first task platform is implemented as an activity center, and the second task platform is implemented as a formal activity center. For example, FIG. 13 is a timing diagram of communication between a client and a server according to some embodiments. As shown in FIG. 13, the method includes the following operations.

Operation 1310: The client requests a current activity center state.

The activity center state includes a locked state, an actively unlockable state, an automatically unlocked receivable reward state, an unlocked and received reward state, and the like.

For example, FIG. 14 is a schematic diagram of an event-driven task platform state according to some embodiments. As shown in FIG. 14, based on an activity center being in a locked state 1410, the activity center may be driven to enter an actively unlockable state 1421 through an event 1411 of obtaining an unlocking item, or may be driven to enter an automatically unlocked receivable reward state 1422 through an event 1412 of minimum condition unlocking. A final state of the activity center is an unlocked and received reward state 1430.

Operation 1320: The server replies the current activity center state.

For example, based on a first account of the client logging in for the first time within a preset historical period of time, the activity center is in the locked state, and the server replies that the current activity center state is the locked state.

Operation 1330: The server notifies a state change.

For example, based on the first account of the client obtaining an unlocking item, the activity center state changes to the actively unlockable state, and the server notifies the client that the activity center state changes to the actively unlockable state.

Operation 1340: The client requests to unlock the formal activity center.

For example, the first account of the client triggers an unlocking operation, and the client requests the server to unlock the formal activity center.

Operation 1350: The server answers to unlock the formal activity center.

For example, the first account of the client meets an actively unlockable condition, the server answers to unlock the formal activity center, and sends task information included in the formal activity center to the client.

In summary, according to the method provided by some embodiments, a communication timing procedure between the client and the server is provided, thereby improving the task platform display method, implementing switching of the task platform state, and improving efficiency of task interaction.

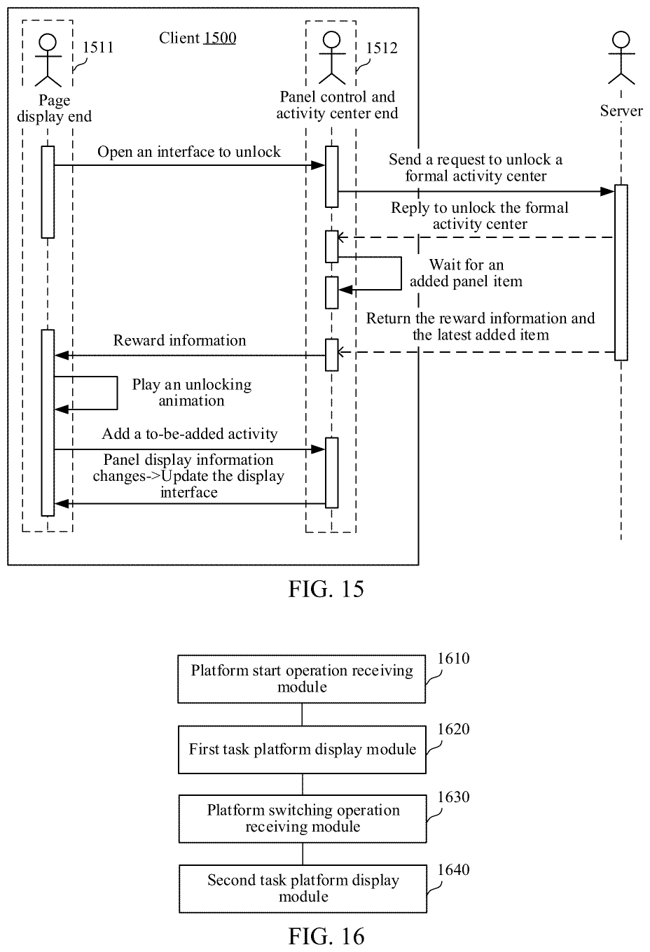

For example, FIG. 15 is a schematic diagram of the logic of a client according to some embodiments. As shown in FIG. 15, the client 1500 includes a page display end 1511 and a panel control and activity center end 1512. Based on the first account triggering an unlocking operation, the client actively requests to unlock the formal activity center, and manages performance before and based on the formal activity center being unlocked. First, based on the first account opening an interface on the client 1500 to use an item to unlock the activity center, for example, the page display end 1511 instructs the panel control and activity center terminal 1512 to open the interface to unlock, the panel control and activity center end 1512 initiates a request to a server side to unlock the formal activity center, and the server side responds and pushes new activity center data. In this case, the client does not refresh the interface, for example, the panel control and activity center end 1512 waits to receive update information, and the page display end 1511 does not display a new activity center. Based on the server side notifying that the unlocking is successful and delivers a reward for unlocking the formal activity center, the panel control and activity center end 1512 sends reward information of the formal activity center to the page display end 1511. The client displays an unlocked reward in response to the page display end 1511 and plays an interface unlocking animation. The page display end 1511 collects new activity center data from the panel control and activity center end 1512, and based on the playing of the unlocking animation ending, the page display end 1511 refreshes the interface to display a new activity center style and a new activity list.

In summary, according to the method provided by some embodiments, the execution logic of the client is clear, display of task platform switching is implemented, smoothness of task platform switching is improved, and user experience is improved.

In some embodiments, to improve the flexibility, reusability, and scalability of a task platform display system, some implementation logics may be configured as configurable items, and logic changes may be quickly brought into effect through a configuration management tool. For example, the configurable items include an unlocked object, an award that may be issued based on unlocking, a minimum condition to be reached for unlocking, an activity that may be displayed in an activity center, and the like. The system may also be quickly used on another requirement than task platform display. This is not limited.

FIG. 16 is a structural block diagram of a task platform display apparatus according to some embodiments. As shown in FIG. 16, the apparatus includes the following parts:

a platform start operation receiving module 1610, configured to receive a task platform start operation, the task platform start operation being configured for starting a task platform corresponding to a first account;

a first task platform display module 1620, configured to display a first task platform in response to the task platform start operation and the first account corresponding to a first task permission, the first task platform including a first number of first task options;

a platform switching operation receiving module 1630, configured to receive a platform switching operation, the platform switching operation being configured for switching the task platform corresponding to the first account from the first task platform to a second task platform; and

a second task platform display module 1640, configured to display the second task platform in response to the platform switching operation and the first account corresponding to a second task permission, the second task platform including a second number of second task options, the first number being less than the second number.

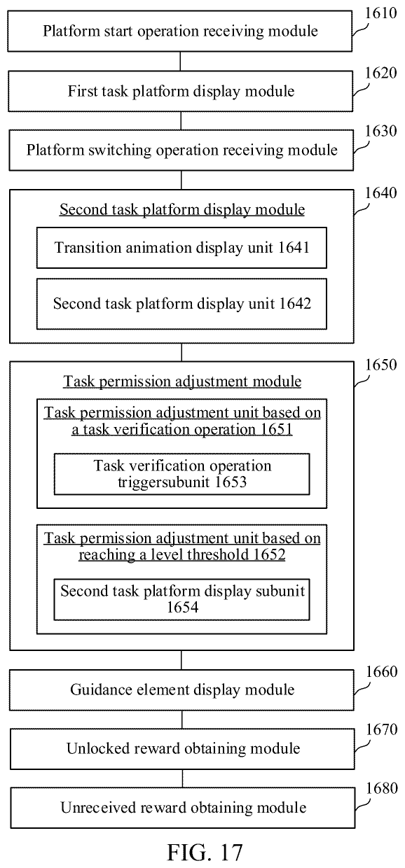

As shown in FIG. 17, in some embodiments, the second task platform display module 1640 includes:

a transition animation display unit 1641, configured to display a platform switching transition animation in response to the platform switching operation and the first account corresponding to the second task permission, the platform switching transition animation being a transition animation for switching the task platform corresponding to the first account from the first task platform to the second task platform; and

a second task platform display unit 1642, configured to display the second task platform in response to the end of playing of the platform switching transition animation.

In some embodiments, the transition animation display unit 1641 is configured to: display an unlocking animation in response to the platform switching operation and the first account corresponding to the second task permission, the unlocking animation being configured for indicating to unlock the second task platform based on the first task platform; and display the platform switching transition animation in response to the end of playing of the unlocking animation.

In some embodiments, the platform switching operation is a switching operation performed by the first account for the first time from a preset historical moment.

In some embodiments, the apparatus further includes: a task permission adjustment module 1650, configured to adjust a task permission corresponding to the first account from the first task permission to the second task permission.

In some embodiments, the task permission adjustment module 1650 includes a task permission adjustment unit based on a task verification operation 1651, or a task permission adjustment unit based on reaching a level threshold 1652. The task permission adjustment unit based on a task verification operation 1651 is configured to adjust the task permission corresponding to the first account from the first task permission to the second task permission in response to the task verification operation and the first account corresponding to the first task permission, the task verification operation being configured for triggering to adjust the task permission corresponding to the first account from the first task permission to the second task permission. The task permission adjustment unit based on reaching a level threshold 1652 is configured to adjust the task permission corresponding to the first account from the first task permission to the second task permission in response to the first account reaching a preset level threshold and the first account corresponding to the first task permission, where based on the first account corresponding to the first task permission, a level of the first account is less than the level threshold, and based on the first account corresponding to the second task permission, the level of the first account is greater than or equal to the level threshold.

In some embodiments, the task permission adjustment unit 1651 based on a task verification operation further includes a task verification operation trigger subunit 1653, the task verification operation trigger subunit 1653 being configured to trigger the task verification operation in a case that the preset task is completed. The preset task includes at least one of the following tasks:
a task configured based on preference information corresponding to the first account;
a task configured based on account information corresponding to the first account; and
a task configured based on capability information corresponding to the first account.

In some embodiments, the task permission adjustment unit based on reaching a level threshold 1652 further includes a second task platform display subunit 1654, the second task platform display subunit 1654 being configured to display the second task platform in response to the task platform start operation.

In some embodiments, the second task platform display subunit 1654 is further configured to: display third reward prompt information in response to the task platform start operation, the third reward prompt information being configured for prompting a reward obtained by the first account after unlocking the second task platform based on the level threshold; and display the second task platform in response to the display of the third reward prompt information being completed.

In some embodiments, the apparatus further includes a guidance element display module 1660, configured to display a guidance element on the first task platform in response to the first account corresponding to the second task permission, the guidance element being configured for prompting to trigger the platform switching operation.

In some embodiments, the apparatus further includes an unlocked reward obtaining module 1670, configured to display first reward prompt information in response to the platform switching operation and the first account corresponding to the second task permission, the first reward prompt information being configured for prompting a reward obtained by the first account after unlocking the second task platform based on the first task platform.

In some embodiments, the apparatus further includes an unreceived reward obtaining module 1680, configured to display second reward prompt information in response to the platform switching operation and the first account corresponding to the second task permission, the second reward prompt information being configured for prompting a reward not received by the first account in the first task platform, and the second reward prompt information corresponding to a completed task in the first task platform, the completed task being configured in the first task platform and not configured in the second task platform.

In summary, according to the task platform display apparatus provided by some embodiments, a first task platform with less tasks is displayed before a second task platform with more tasks is displayed. The first task platform refers to an activity center provided for users and displaying less tasks. Based on a user triggering a platform switching operation and a task permission of the user is adjusted from a first task permission to a second task permission, the first task platform is switched to the second task platform, and the second task platform displays more tasks. By displaying the task platform in stages, the user is given a transitional experience to the task platform, thereby improving the attention of the user in the task at each stage, so that efficiency of human-computer interaction between the user and the task is improved.

The apparatus for displaying a task platform provided in the foregoing embodiments is illustrated with an example of division of the foregoing functional modules or units. In actual application, the functions may be allocated to and completed by different functional modules or units according to requirements. For example, the internal structure of the device may be divided into different functional modules, to implement all or some of the functions described above. Some modules or units may be further split into multiple smaller function subunits, thereby implementing the same operations without affecting the technical effects of some embodiments. In some embodiments, the apparatus may further include other modules or units. In actual applications, these functions may also be realized cooperatively by the other modules or units, and may be realized cooperatively by multiple modules or units. In addition, the task platform display apparatus provided in the foregoing embodiment belongs to the same idea as the task platform display method according to some embodiments. For implementation details, reference may be made to the method according to some embodiments.

A person skilled in the art would understand that these “modules” or “units” could be implemented by hardware logic, a processor or processors executing computer software code, or a combination of both. The “modules” or “units” may also be implemented in software stored in a memory of a computer or a non-transitory computer-readable medium, where the instructions of each unit are executable by a processor to thereby cause the processor to perform the respective operations of the corresponding unit.

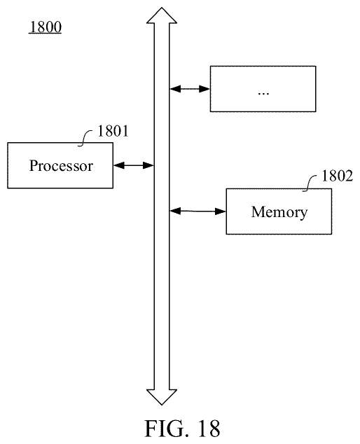

FIG. 18 is a structural block diagram of a terminal 1800 according to some embodiments. The terminal 1800 may be a smartphone, a tablet computer, a Moving Picture Experts Group Audio Layer III (MP3) player, a Moving Picture Experts Group Audio Layer IV (MP4) player, a notebook computer, or a desktop computer. The terminal 1800 may also be referred to as other names such as a user equipment, a portable terminal, a laptop terminal, or a desktop terminal.

The terminal 1800 may include: a processor 1801 and a memory 1802.

The processor 1801 may include one or more processing cores, such as a 4-core processor or an 8-core processor. The processor 1801 may be implemented by using at least one hardware form of a digital signal processor (DSP), a field-programmable gate array (FPGA), and a programmable logic array (PLA). The processor 1801 may also include a main processor and a coprocessor. The main processor is a processor configured to process data in an active state, also referred to as a central processing unit (CPU). The coprocessor is a low-power consumption processor configured to process data in a standby state. In some embodiments, the processor 1801 may be integrated with a graphics processing unit (GPU). The GPU is configured to be responsible for rendering and drawing content to be displayed in a display. In some embodiments, the processor 1801 may further include an artificial intelligence (AI) processor. The AI processor is configured to process a computing operation related to machine learning.

The memory 1802 may include one or more computer-readable storage media. The computer-readable storage media may be non-transitory. The memory 1802 may further include a high-speed random access memory and a non-volatile memory, such as one or more disk storage devices and flash storage devices. In some embodiments, a non-transitory computer-readable storage medium in the memory 1802 is configured to store at least one instruction, the at least one instruction being configured to be executed by the processor 1801 to implement the task platform display method provided in the method according to some embodiments.

In some embodiments, the terminal 1800 further include another component. A person skilled in the art may understand that the structure shown in FIG. 18 does not constitute a limitation to the terminal 1800, and the terminal 1800 may include more or fewer components than those shown in the figure, or some components may be combined, or a different component deployment may be used.

Some embodiments provide a computer device. The computer device may be implemented as the terminal or the server shown in FIG. 1. The computer device includes a processor and a memory. The memory has at least one instruction stored therein, at least one program, a code set, or an instruction set, the at least one instruction, the at least one program, the code set, or the instruction set being loaded and executed by the processor to implement the task platform display method according to the foregoing method embodiments.

Some embodiments provide a computer-readable storage medium. The computer-readable storage medium has at least one instruction stored therein, at least one program, a code set, or an instruction set, the at least one instruction, the at least one program, the code set, or the instruction set being loaded and executed by a processor to implement the task platform display method according to the foregoing method embodiments.

Some embodiments provide a computer program product or a computer program. The computer program product or the computer program includes computer instructions, the computer instructions being stored in a computer-readable storage medium. A processor of a computer device reads the computer instructions from the computer-readable storage medium, and executes the computer instructions, to cause the computer device to perform the task platform display method according to any one of the foregoing embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A task platform display method, performed by a terminal, comprising:
receiving a start operation for starting a task platform corresponding to a first account;
displaying, based on the start operation and the first account corresponding to a first task permission, a first task platform comprising a first number of first task options;
receiving a platform switching operation for switching the task platform from the first task platform to a second task platform comprising a second number of second task options, the first number being less than the second number; and
displaying, based on the platform switching operation and the first account corresponding to a second task permission, the second task platform.

2. The method according to claim 1, wherein the displaying the second task platform comprises:
displaying, based on the platform switching operation and the first account corresponding to the second task permission, a platform switching transition animation for switching the task platform from the first task platform to the second task platform; and
displaying, based on an end of playing the platform switching transition animation, the second task platform.

3. The method according to claim 2, wherein the displaying the platform switching transition animation comprises:
displaying, based on the platform switching operation and the first account corresponding to the second task permission, an unlocking animation indicating to unlock the second task platform based on the first task platform; and
displaying, based on an end of playing the unlocking animation, the platform switching transition animation.

4. The method according to claim 2, wherein the platform switching operation is performed by the first account for a first time from a preset historical moment.

5. The method according to claim 1, wherein the method further comprises displaying, based on the platform switching operation and the first account corresponding to the second task permission, first reward prompt information for prompting a reward obtained by the first account after unlocking the second task platform based on the first task platform.

6. The method according to claim 1, wherein the method further comprises displaying, based on the platform switching operation and the first account corresponding to the second task permission, second reward prompt information for prompting a reward not received by the first account in the first task platform,
wherein the second reward prompt information corresponds to a completed task in the first task platform, and
wherein the completed task is provided in the first task platform and is not provided in the second task platform.

7. The method according to claim 1, wherein the task platform is an element displayed in a virtual scene provided by the terminal, the first account corresponds to a first virtual character, and the first task platform corresponds to a first virtual space,
wherein the displaying the first task platform comprises displaying, based on the start operation and the first account corresponding to the first task permission, the first virtual character entering the first virtual space, and
wherein the first virtual space comprises one or more first subspaces respectively corresponding to the first number.

8. The method according to claim 7, wherein the receiving the platform switching operation comprises:
receiving a control operation for the first virtual character in the virtual scene; and
triggering, based on a distance between the first virtual character and a first virtual element in the first virtual space being less than or equal to a preset distance, a first platform switching operation for switching a virtual space in which the first account is located from the first virtual space to a second virtual space corresponding to the second task platform, and
wherein the second virtual space comprises one or more second subspaces respectively corresponding to the second number.

9. The method according to claim 1, wherein the method further comprises adjusting a task permission corresponding to the first account from the first task permission to the second task permission.

10. The method according to claim 9, wherein the adjusting the task permission comprises:
adjusting the task permission based on:
a task verification operation for triggering to adjust the task permission corresponding to the first account from the first task permission to the second task permission, and
the first account corresponding to the first task permission, the task verification operation being configured; or
adjusting the task permission based on the first account reaching a preset level threshold and the first account corresponding to the first task permission, wherein based on the first account corresponding to the first task permission, a level of the first account is less than the preset level threshold, and based on the first account corresponding to the second task permission, the level of the first account is greater than or equal to the preset level threshold.

11. A task platform display apparatus, comprising:
at least one memory configured to store computer program code; and
at least one processor configured to read the program code and operate as instructed by the program code, the program code comprising:
platform start operation code configured to cause at least one of the at least one processor to receive a start operation for starting a task platform corresponding to a first account;
first task platform display code configured to cause at least one of the at least one processor to display, based on the start operation and the first account corresponding to a first task permission, a first task platform comprising a first number of first task options;
platform switching code configured to cause at least one of the at least one processor to receive a platform switching operation for switching the task platform from the first task platform to a second task platform comprising a second number of second task options, the first number being less than the second number; and
second task platform display code configured to cause at least one of the at least one processor to display, based on the platform switching operation and the first account corresponding to a second task permission, the second task platform.

12. The apparatus according to claim 11, wherein the second task platform display code comprises:
transition animation display code configured to cause at least one of the at least one processor to display, based on the platform switching operation and the first account corresponding to the second task permission, a platform switching transition animation for switching the task platform from the first task platform to the second task platform; and
second task platform transition display code configured to cause at least one of the at least one processor to display, based on an end of playing the platform switching transition animation, the second task platform.

13. The apparatus according to claim 12, wherein the transition animation display code is configured to cause at least one of the at least one processor to:
display, based on the platform switching operation and the first account corresponding to the second task permission, an unlocking animation indicating to unlock the second task platform based on the first task platform; and
display, based on an end of playing the unlocking animation, the platform switching transition animation.

14. The apparatus according to claim 12, wherein the platform switching operation is performed by the first account for a first time from a preset historical moment.

15. The apparatus according to claim 11, wherein the apparatus further comprises reward prompt code configured to cause at least one of the at least one processor to display, based on the platform switching operation and the first account corresponding to the second task permission, first reward prompt information for prompting a reward obtained by the first account after unlocking the second task platform based on the first task platform.

16. The apparatus according to claim 11, wherein the apparatus further comprises reward prompt code configured to cause at least one of the at least one processor to display, based on the platform switching operation and the first account corresponding to the second task permission, second reward prompt information for prompting a reward not received by the first account in the first task platform,
wherein the second reward prompt information corresponds to a completed task in the first task platform, and
wherein the completed task is provided in the first task platform and is not provided in the second task platform.

17. The apparatus according to claim 11, wherein the task platform is an element displayed in a virtual scene, the first account corresponds to a first virtual character, and the first task platform corresponds to a first virtual space,
wherein the first task platform display code is configured to cause at least one of the at least one processor to display, based on the start operation and the first account corresponding to the first task permission, the first virtual character entering the first virtual space, and
wherein the first virtual space comprises one or more first subspaces respectively corresponding to the first number.

18. The apparatus according to claim 17, wherein the platform switching code is configured to cause at least one of the at least one processor to:
receive a control operation for the first virtual character in the virtual scene; and
trigger, based on a distance between the first virtual character and a first virtual element in the first virtual space being less than or equal to a preset distance, a first platform switching operation for switching a virtual space in which the first account is located from the first virtual space to a second virtual space corresponding to the second task platform, and
wherein the second virtual space comprises one or more second subspaces respectively corresponding to the second number.

19. The apparatus according to claim 11, wherein the apparatus further comprises adjusting code configured to cause at least one of the at least one processor to adjust a task permission corresponding to the first account from the first task permission to the second task permission.

20. A non-transitory computer-readable storage medium, storing computer code which, when executed by at least one processor, causes the at least one processor to at least:
receive a start operation for starting a task platform corresponding to a first account;
display, based on the start operation and the first account corresponding to a first task permission, a first task platform comprising a first number of first task options;
receive a platform switching operation for switching the task platform from the first task platform to a second task platform comprising a second number of second task options, the first number being less than the second number; and
display, based on the platform switching operation and the first account corresponding to a second task permission, the second task platform.
